(19) United States
(12) Patent Application Publication
(10) Pub. No.: US 2016/0288578 A1
(43) Pub. Date: Oct. 6, 2016

(54) PNEUMATIC TIRE WITH ASYMMETRICAL RIBS AND PADDLES

(71) Applicant: Sand Tires Unlimited, Inc., Temecula, CA (US)

(72) Inventor: MARK J. HARMS, Murrieta, CA (US)

(21) Appl. No.: 15/089,794

(22) Filed: Apr. 4, 2016

Related U.S. Application Data
(60) Provisional application No. 62/142,580, filed on Apr. 3, 2015.

(51) Int. Cl. B60C 11/03; B60C 13/00; B60C 11/13; B60C 9/02

(52) U.S. Cl. CPC B60C 11/0316; B60C 9/02; B60C 13/00; B60C 11/0304; B60C 11/1307

(57) ABSTRACT

Described is a pneumatic tire having a reinforced carcass with a tread support portion straddled by two sidewall portions. Tread rises from the reinforced carcass and includes one or more annular ribs extending completely around a periphery of the tire such that the one or more annular ribs are laterally offset in relation to a center plane passing through the reinforced carcass. Further, a plurality of converging paddle pairs are formed in the tread and surround the periphery of the tire. Each paddle pair includes two facing paddles having inwardly curving paddle faces, with the two facing paddles converging toward one another such that a distance between the two facing paddles decreases as the paddles traverse from the inner annular rib toward the sidewall portion. The inwardly curving paddle faces allow the tire to both push and pull, while the annular ribs provide enhanced steering support.

### CROSS-REFERENCE TO RELATED APPLICATIONS

This is a Non-Provisional Utility Patent Application of U.S. Provisional Application No. 62/142,580, filed on Apr. 3, 2015, entitled, “Tire with Asymmetrical Ribs and Paddles,” the entirety of which is incorporated herein by reference.

### BACKGROUND OF THE INVENTION

(1) Field of Invention

The present invention generally relates to pneumatic tires for use on off-road vehicles and, more particularly, to pneumatic tires having a tread pattern that provides for steering, pulling, and pushing in sand.

(2) Description of Related Art

Pneumatic tires are used to support and steer a vehicle and typically include a specifically designed tread pattern or design. Over the years a variety of tread patterns have emerged that are designed for a particular application. By way of example, street driving is typically done on a relatively smooth surface. However, standing water on the road surface can cause a dangerous environment to the driver due to hydroplaning. To reduce this issue, tire patterns have been designed that direct water out to the side of the tire. Thus, instead of hydroplaning, the water is simply redirected by the tire pattern.

Other driving environments, such as when driving off-road while sand duning, require tires that are specifically designed for loose sand. As can be appreciated by those skilled in the art, a traditional car tire is far too slick or smooth to be effective in loose sand. To address this, sand tires have been developed with sufficiently large paddles or tread that are operable for providing mono-directional traction that forcefully push the sand vehicle forward. While sand tires do not get traction (which is what happens when a tire pushes or pulls on a stable surface (i.e., concrete or asphalt)), sand tires operate by displacing weight in manner that is similar to how a propeller on a boat or plane works. In other words, the more sand/weight that can be displaced in a shorter period of time, the faster the vehicle can accelerate forward. Thus, the purpose of the large paddles is to displace the sand and, in doing so, propel the vehicle.

The sand industry in the past 50 years (with a few exceptions) have been two wheel drive vehicles. The overwhelmingly majority of all vehicles used in sand recreation as well as commercial applications has been through the use of rear, and two-wheel drive platforms. The sand industry in the past several years is making yet another evolutional chance regarding vehicle design and drive systems. Today, the most popular vehicle for off-road recreation and commercial use, and including sand is the utility task vehicle (UTV). The vast majority of UTV's being produced are “all-wheel drive”. The need for a specific front tire designed to benefit from the forward and reversing forces of a front axle under power, is a force multiplier with respect to performance advantages.

While most past efforts have been placed on the development of tires for the rear of the sand vehicle, some emphasis has been placed on tires for the front wheels of the sand vehicle. For example, it has been the common practice to use tires designed for wheels of farm implements as the front tires of sand cars. Such tires typically have relatively smooth or annularly grooved tread surfaces, or treads of the mohawk style having a single central annular raised lug and substantially smooth surfaces on each lateral side of the lug to minimize the amount of sand thrown up by the tires. The annular raised lug provides lateral traction to assist in steering the sand vehicle. While effective for steering, such tires provide little driving (pushing) force to the vehicle.

Thus, a continuing need exists for pneumatic tires having a tread pattern that provides for steering, pulling, and pushing in sand.

### SUMMARY OF INVENTION

This disclosure provides a pneumatic tire. The pneumatic tire comprises a reinforced carcass having a tread support portion straddled by two sidewall portions. Tread rises from the reinforced carcass and includes one or more annular ribs extending completely around a periphery of the tire such that the one or more annular ribs are laterally offset in relation to a center plane passing through the reinforced carcass. Additionally, a plurality of converging paddle pairs formed in the tread and surrounding the periphery of the tire.

In another aspect, the one or more annular ribs includes an outer annular rib and an inner annular rib, each of which extend completely around the tire periphery and are laterally offset in relation to the center plane toward one of the sidewall portions.

In yet another aspect, the outer annular rib includes an outer surface that extends up and away from the center plane to an outer rib face.

In another aspect, the outer rib face curves inward toward the center plane.

In yet another aspect, the inner annular rib includes an outer surface that extends away from the center plane to an inner rib face.

Further, the inner rib face is substantially parallel with the center plane.

In yet another aspect, each paddle pair includes two facing paddles having inwardly curving paddle faces, with the two facing paddles converging toward one another such that a distance between the two facing paddles decreases as the paddles traverse from the inner annular rib toward the sidewall portion.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a left, perspective-view illustration a pneumatic tire according to the principles of the present invention, depicting the pneumatic tires tread pattern;

FIG. 2 is a right, perspective-view illustration the pneumatic tire according to the principles of the present invention;

FIG. 3 is a front-view illustration the pneumatic tire according to the principles of the present invention;

FIG. 4 is a left-view illustration the pneumatic tire according to the principles of the present invention;

FIG. 5 is a right-view illustration the pneumatic tire according to the principles of the present invention;

FIG. 6 is a cross-sectional view illustration the pneumatic tire according to the principles of the present invention, taken from line 6 of FIG. 3;

FIG. 7 is a cross-sectional view illustration a paddle of the pneumatic tire according to the principles of the present invention, taken from line 7 of FIG. 3; and

FIG. 8 is a front-view illustration the pneumatic tire according to the principles of the present invention, depicting example measurements for the tread pattern.

### DETAILED DESCRIPTION

The present invention generally relates to pneumatic tires for use on off-road vehicles and, more particularly, to pneumatic tires having a tread pattern that provides for steering, pulling, and pushing. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

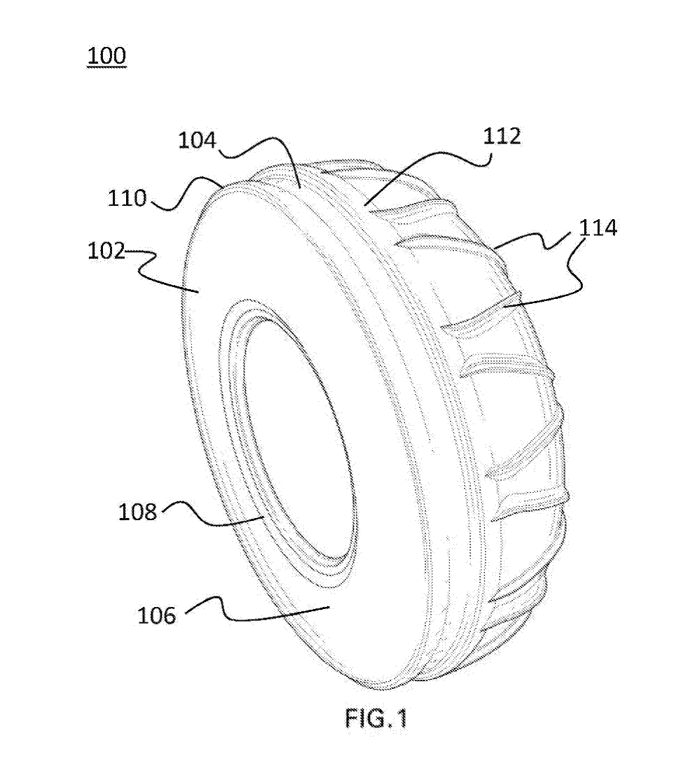

As noted above and as shown in FIG. 1, this disclosure is directed to a pneumatic tire 100 having a tread pattern that provides for steering, pulling, and pushing. Due to its unique tread pattern and functionality, the pneumatic tire 100 can be used as a front tire or rear tire on a sand car or any other suitable vehicle. The specific features of the tire 100 are described in further detail below.

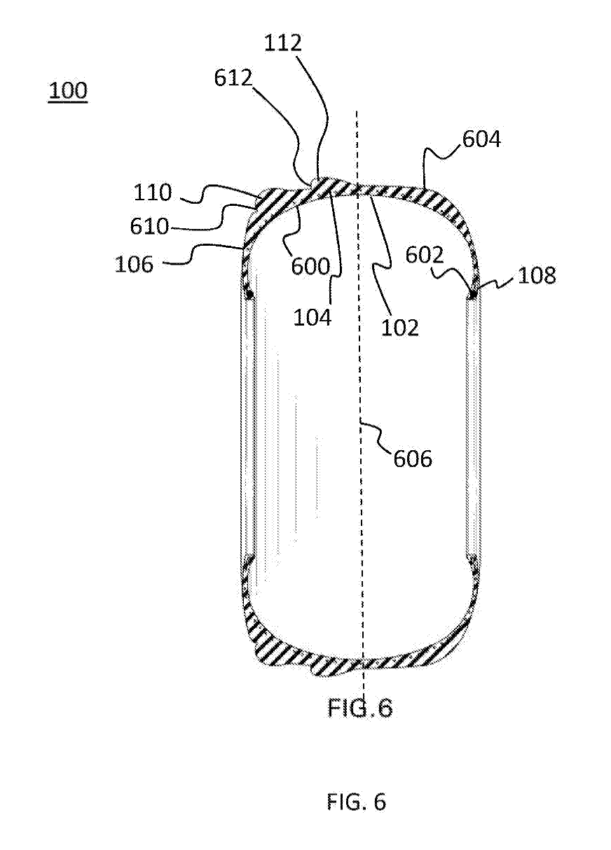

Referring now to the drawings in detail and as shown in FIGS. 1 and 6, the pneumatic tire 100 generally comprises a reinforced carcass 102 having a tread support portion 104 and generally radially inwardly extending opposed sidewall portions 106 each terminating in a bead 108. The tread support portion 104 and sidewall portions 106 are integrally joined at transitional or shoulder areas to desirably provide a smooth generally dome-shaped or curved profile to the inner surface 600 of the tread support portion 104 of the tire 100, as seen in the cross-section of FIG. 6.

It should be noted that the dome-shaped or curved profile of the inner surface 600 is not required but is provided as a desirable non-limiting example of a suitable shape for the inner surface 600 to distribute forces. In some embodiments, the bead 108 is reinforced with a steel cable 602 or other material that is embedded within the bead 108 and passes around the entire circumference of the bead 108, thereby creating a reinforced bead.

The tire 100 can be formed of any suitably durable material(s) as appropriate for use in a pneumatic tire as understood by those skilled in the art, non-limiting examples of which include rubber, steel, fibers, etc. In some embodiments, a coating or layer of elastomeric material 604 extends over and is vulcanized to the outer surface of the carcass 102 with the elastomeric coating being thicker in the tread area and being shaped to provide the unique tread described more fully herein below.

In some embodiments and as shown in FIG. 6, the tire carcass 102 is symmetrical on opposed sides of its vertical center plane 606, i.e., a plane perpendicular to the axis of rotation of the tire and located midway between the sidewall portions 106; however, the elastomeric material 604 integrally vulcanized to the carcass 102 is asymmetrical at least in the portion thereof defining the tread or ground engaging portion of the tire. Thus, in some embodiments, the elastomeric material 604 forms the tread, while in other embodiments, the outer shape of the carcass 102 itself forms the tread. For example, the carcass 102 can be integrally molded to form the entire tire, including the tread.

Notably and as shown throughout the figures, the tread of the tire 100 includes an outer annular rib 110 and an inner annular rib 112, each of which extend completely around the tire 100 periphery and are laterally offset in relation to the center plane 606 toward one of the sidewall portions 106. The outer annular rib 110 includes an outer surface that extends up and/or laterally away from the center plane 606 to an outer rib face 610. The outer rib face 610 ends at the sidewall portion 106. In some embodiments, the outer rib face 610 is substantially parallel with the center plane. In another embodiment and as shown in FIG. 6, the outer rib face 610 curves inward toward the center plane 606 to provide an increased traction or grasping surface while steering the vehicle.

The inner annular rib 112 includes an outer surface that extends up and/or laterally away from the center plane 606 to an inner rib face 612, which falls to the outer tread 104. In some embodiments, the inner rib face 612 curves inward toward the center plane 606. In another embodiment and as shown in FIG. 6, the inner rib face 612 is substantially parallel with the center plane 606.

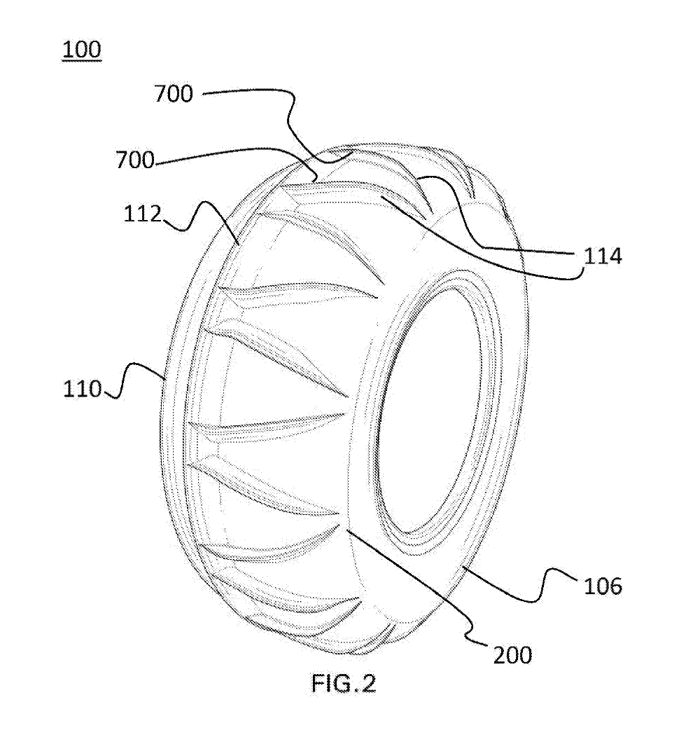

To provide for both pulling and pushing, a plurality of converging paddle pairs 114 flow from the inner annular rib 112 and toward a sidewall portion 106 opposite that closest to the outer annular rib 110. As shown throughout FIGS. 2, 3, and 7, the paddle pair 114 includes two facing paddles having inwardly curving paddle faces 700. The two facing paddles traverse from the inner annular rib 112 and converge toward one another such that a distance between the two facing paddles decreases as the paddles traverse from the inner annular rib 112 toward the sidewall portion 106. As shown in FIG. 2, the two facing paddles decrease in height and blend smoothly into a shoulder portion 200 of the sidewall 106.

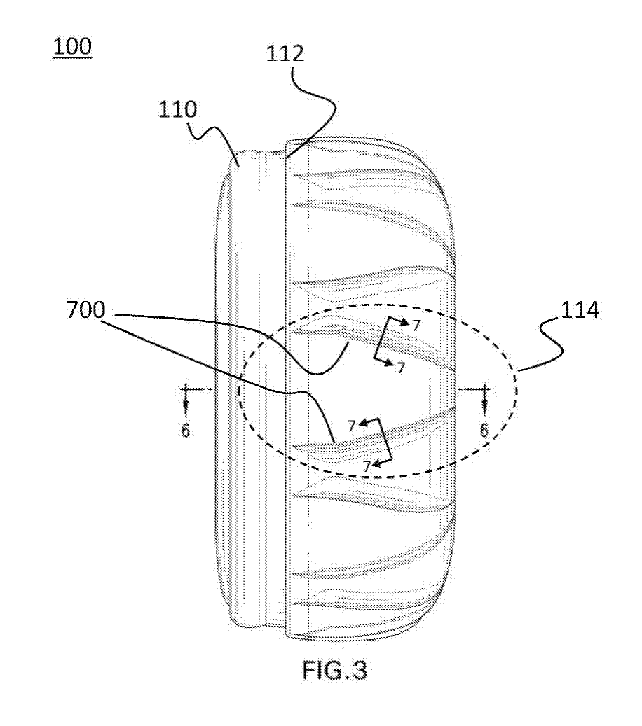

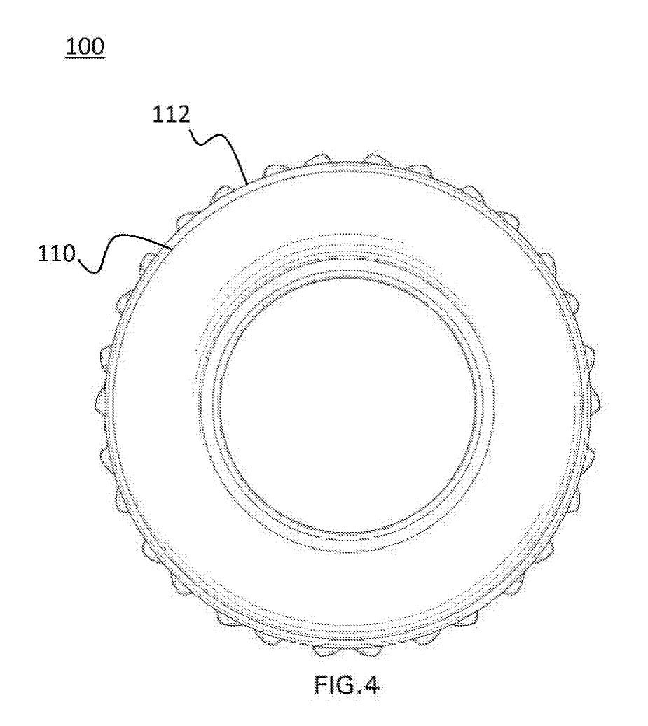

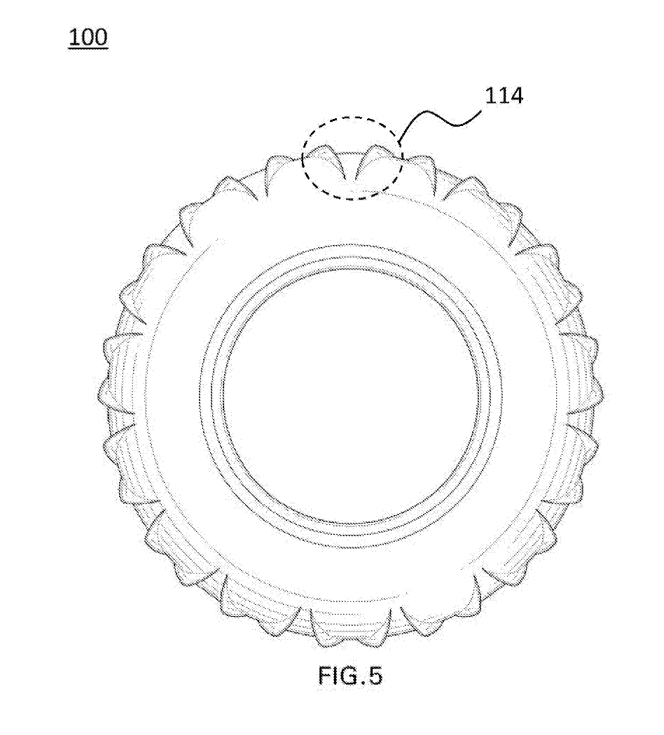

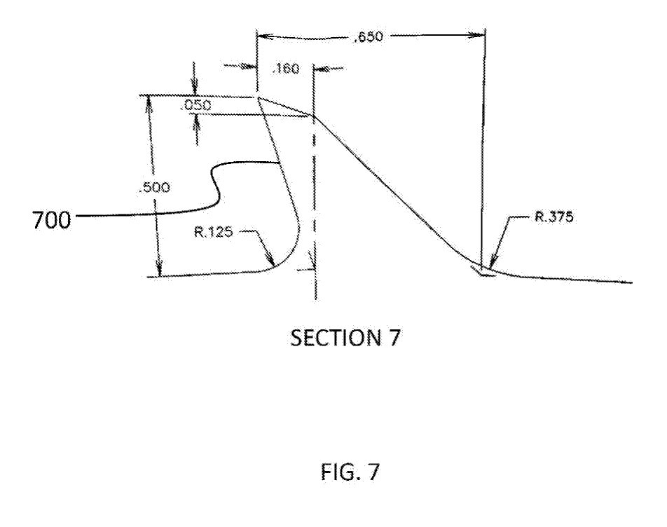

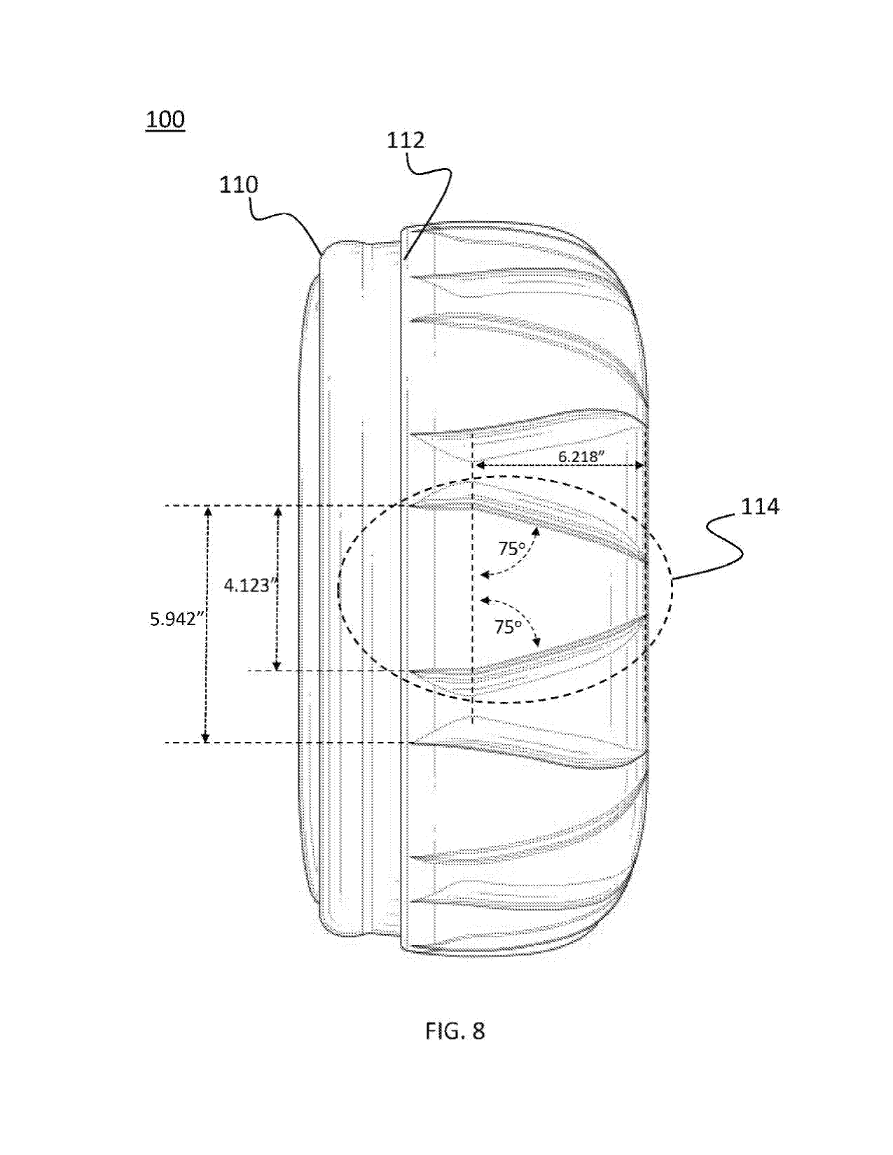

For further understanding, FIGS. 4 and 5 provide left-view and right-view illustrations, respectively, of the pneumatic tire 100. FIG. 4, for example, depicts the outer annular rib 110 and the inner annular rib 112, while FIG. 5 depicts a paddle pair 114 comprised of two facing and converging paddles. As noted above and as depicted in FIG. 7, each paddle in the paddle pair includes an inwardly curving paddle face 700 to provide a grasping surface. More specifically, FIG. 7 is a cross-sectional view illustration a paddle, taken from line 7 of FIG. 3. Each paddle in the paddle pair can be formed of any suitable shape and dimension. For further understanding, FIGS. 7 and 8 provide a non-limiting example of suitable dimensions (in inches) and radii which provide the benefits of pushing and pulling when implemented in a paddle pair 114.

While a desired embodiment of the invention has been illustrated and described, it is understood that various modifications might be made. Accordingly, it is understood that the invention is not limited to the disclosed embodiment, but rather it is intended to include all embodiments which would be apparent to one skilled in the art and which come within the spirit and scope of the invention.

What is claimed is:

1. A pneumatic tire, the pneumatic tire comprising:
a reinforced carcass having a tread support portion straddled by two sidewall portions;
tread rising from the reinforced carcass, wherein the tread includes one or more annular ribs extending completely around a periphery of the tire such that the one or more annular ribs are laterally offset in relation to as center plane passing through the reinforced carcass; and
a plurality of converging paddle pairs formed in the tread and surrounding the periphery of the tire.

2. The pneumatic tire as set forth in claim 1, wherein the one or more annular ribs includes an outer annular rib and an inner annular rib, each of which extend completely around the tire periphery and are laterally offset in relation to the center plane toward one of the sidewall portions.

3. The pneumatic tire as set forth in claim 2, wherein the outer annular rib includes an outer surface that extends up and away from the center plane to an outer rib face.

4. The pneumatic tire as set forth in claim 3, wherein the outs rib face curves inward toward the center plane.

5. The pneumatic tire as set forth in claim 4, wherein the inner annular rib includes an outer surface that extends away from the center plane to an inner rib face.

6. The pneumatic tire as set forth in claim 5, wherein the inner rib face is substantially parallel with the center plane.

7. The pneumatic tire as set forth in claim 6, wherein each paddle pair includes two facing paddles having inwardly curving paddle faces, with the two facing paddles converging toward one another such that a distance between the two facing paddles decreases as the paddles traverse from the inner annular rib toward the sidewall portion.

8. The pneumatic tire as set forth in claim 2, wherein the inner annular rib includes an outer surface that extends away from the center plane to an inner rib face.

9. The pneumatic tire as set forth in claim 8, wherein the inner rib face is substantially parallel with the center plane.

10. The pneumatic tire as set forth in claim 2, wherein each paddle pair includes two facing paddles having inwardly curving paddle faces, with the two facing paddles converging toward one another such that a distance between the two facing paddles decreases as the paddles traverse from the inner annular rib toward the sidewall portion.
